(19) United States
(12) Patent Application Publication
(10) Pub. No.: US 2026/0248071 A1
(43) Pub. Date: Aug. 27, 2026

(54) POSITION CONTROL SYSTEM FOR AN AGRICULTURAL HARVESTER REEL ASSEMBLY

(71) Applicant: CNH Industrial Brasil Ltda., Nova Lima (BR)

(72) Inventors: João Filipe de Rezende Martins, Curitiba (BR); Renato Alves Ribeiro Junior, Campo Largo (BR)

(73) Assignee: CNH Industrial Brasil Ltda., Nova Lima (BR)

(21) Appl. No.: 19/545,845

(22) Filed: Feb. 20, 2026

(30) Foreign Application Priority Data
Feb. 21, 2025 (BR) 1020250034506

(51) Int. Cl. A01D 57/04

(52) U.S. Cl. CPC A01D 57/04

(57) ABSTRACT

A reel assembly of an agricultural harvester includes an arm supporting a reel of the reel assembly, wherein the arm includes an internal passage. The reel assembly also includes a position control system with a motor having a shaft. The position control system also includes a driver non-rotatably coupled to the shaft of the motor. The driver is disposed within the internal passage of the arm, and the motor drives the driver to rotate. In addition, the position control system includes a carriage coupled to the reel. The carriage is disposed within the internal passage of the arm, and the driver drives the carriage to move through the internal passage along a length of the arm in response to rotation of the driver.

### CROSS-REFERENCE TO RELATED APPLICATION

The present disclosure is based upon and claims priority to the Brazilian patent application BR 10 2025 003450 6 filed on February 21, 2025. The entire disclosure of the Brazilian patent application including the specification, drawings, and claims is incorporated herein by reference in its entirety.

### FIELD OF THE DISCLOSURE

The present disclosure relates generally to a position control system for an agricultural harvester reel assembly.

### BACKGROUND

A harvester may be used to harvest agricultural crops, such as barley, beans, beets, carrots, corn, cotton, flax, oats, potatoes, rye, soybeans, wheat, or other plant crops. Furthermore, a combine (e.g., combine harvester) is a type of harvester generally used to harvest certain crops that include grain (e.g., barley, corn, flax, oats, rye, wheat, etc.). During operation of a combine, the harvesting process may begin by removing agricultural crops from a field, such as by using a header. The header may cut the agricultural crops and transport the cut crops to a processing system of the combine.

Certain headers include a cutter bar assembly configured to cut a portion of each crop (e.g., a stalk), thereby separating the cut crop from the soil. The cutter bar assembly may extend along a substantial portion of the width of the header, and the cutter bar assembly may be flexible along the width of the header. The header may also include an auger positioned behind the cutter bar assembly relative to the direction of travel of the harvester. The auger is configured to transport the cut crops to an inlet of the processing system. Certain headers include a reel assembly configured to direct the crops cut by the cutter bar assembly toward the auger, thereby substantially reducing the possibility of the cut crops falling onto the surface of the field.

Certain reel assemblies include a reel having a rotating structure, multiple bat tubes rotatably coupled to the rotating structure, and multiple tines coupled to each bat tube. The rotating structure is driven to rotate such that the bat tubes move in a circular pattern, and a tine rotation mechanism is configured to drive the bat tubes to rotate relative to the rotating structure. The tines are configured to engage the cut crops and to urge the cut crops to move toward the auger. The reel is typically supported by multiple arms extending from a frame of the header.

### BRIEF DESCRIPTION

In certain embodiments, a reel assembly of an agricultural harvester includes an arm supporting a reel of the reel assembly, in which the arm has an internal passage. The reel assembly also includes a position control system including a motor having a shaft. The position control system also includes a driver non-rotatably coupled to the shaft of the motor. The driver is disposed within the internal passage of the arm, and the motor drives the driver to rotate. In addition, the position control system includes a carriage coupled to the reel. The carriage is disposed within the internal passage of the arm, and the driver drives the carriage to move through the internal passage along a length of the arm in response to rotation of the driver.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header.

FIG. 2 is a perspective view of an embodiment of a header that may be employed within the agricultural harvester of FIG. 1.

FIG. 3 is a perspective view of an embodiment of an arm and an embodiment of a position control system that may be employed within the header of FIG. 2.

FIG. 4 is a cross-sectional view of a portion of the arm and a portion of the position control system of FIG. 3.

FIG. 5 is a perspective view of the arm of FIG. 3 and another embodiment of a position control system that may be employed within the header of FIG. 2.

FIG. 6 is a perspective view of another embodiment of an arm and a further embodiment of a position control system that may be employed within the header of FIG. 2.

FIG. 7 is a perspective view of an embodiment of a carriage that may be employed within the position control system of FIG. 6; and .

FIG. 8 is a block diagram of an embodiment of a portion of a position control system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

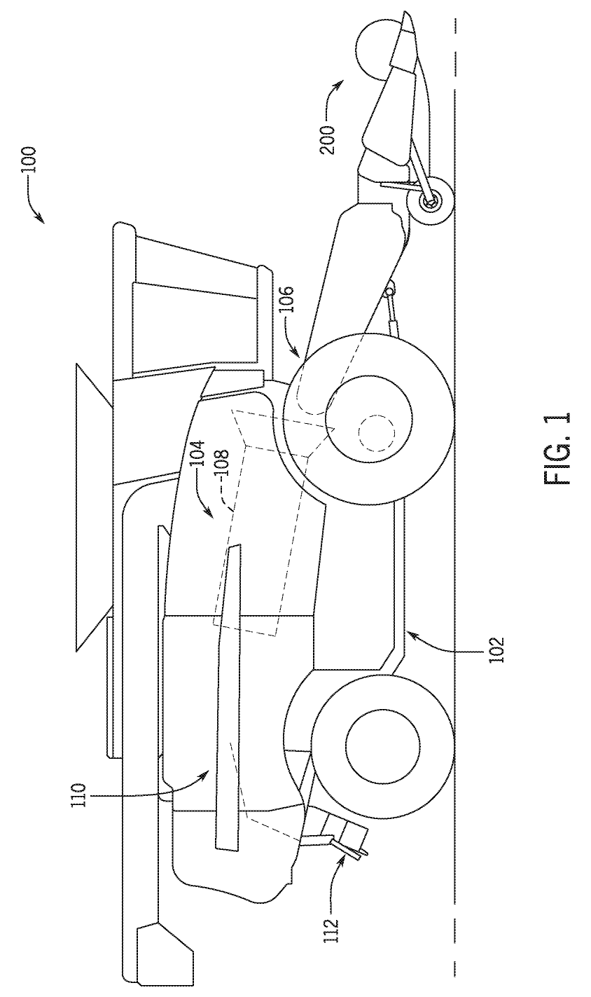

FIG. 1 is a side view of an embodiment of an agricultural harvester 100 having a header 200 (e.g., agricultural header). The agricultural harvester 100 includes a chassis 102 supporting the header 200 and an agricultural crop processing system 104. As described in greater detail below, the header 200 cuts crops and transports the cut crops toward an inlet 106 of the agricultural crop processing system 104 for further processing of the cut crops. The agricultural crop processing system 104 receives cut crops from the header 200 and separates desired crop material from crop residue. For example, the agricultural crop processing system 104 may include a thresher 108 having a cylindrical threshing rotor that transports the crops in a helical flow path through the harvester 100. In addition to transporting the crops, the thresher 108 may separate certain desired crop material (e.g., grain) from the crop residue, such as husks and pods, and enable the desired crop material to flow into a cleaning system located beneath the thresher 108. The cleaning system may remove debris from the desired crop material and transport the desired crop material to a storage compartment within the harvester 100. The crop residue may be transported from the thresher 108 to a crop residue handling system 110, which may remove the crop residue from the harvester 100 via a crop residue spreading system 112 positioned at the aft end of the harvester 100.

As discussed in detail below, the header 200 includes a cutter bar assembly that cuts the crops within the field. The header 200 also includes a reel assembly urges crops cut by the cutter bar assembly to an auger that conveys the cut crops toward the inlet 106 of the agricultural crop processing system 104. As discussed in detail below, the reel assembly includes a reel having a rotating structure be driven in rotation. The reel also includes multiple bat tubes rotatably coupled to the rotating structure. Furthermore, the reel includes multiple tines coupled to each bat tube. A tine rotation mechanism (e.g., a cam and follower assembly or a parallel state assembly) is configured to drives the bat tubes to rotate in response to rotation of the rotating structure. Accordingly, the tines rotate in a first pattern (e.g., circular pattern) about a rotational axis of the rotating structure and in second patterns (e.g., circular patterns or oscillating patterns) about rotational axes of respective bat tubes. The tines engage the cut crops and to urge the cut crops to move toward the auger.

The reel is supported by arms positioned on opposite lateral ends of the header 200. The arms are rotate upwardly and downwardly to adjust the vertical position of the reel, and the reel moves along the length of the arms. As discussed in detail below, at least one arm has an internal passage. In addition, the reel assembly of the header 200 includes a position control system that controls the position of the reel along the length of the arm. In certain embodiments, the position control system includes a motor having a shaft. The position control system also includes a driver (e.g., threaded shaft) non-rotatably coupled to the shaft of the motor. The driver is disposed within the internal passage of the arm, and the motor is configured to drives the driver to rotate. In addition, the position control system includes a carriage coupled to the reel. The carriage is disposed within the internal passage of the arm, and the driver drives the carriage to move through the internal passage along the length of the arm in response to rotation of the driver. Accordingly, the position control system may control the position of the reel along the length of the arm.

Because the driver and the carriage are disposed within the internal passage of the arm, the arm may substantially block dirt, debris, and chaff, which may be present in significant amounts during operation of the agricultural harvester, from engaging the driver and the carriage, thereby substantially reducing cleaning and maintenance operations (e.g., as compared to an actuator, such as a hydraulic cylinder, positioned outside the arm). In certain embodiments, the motor includes an electric motor, such that the reel is driven to move along the arm using the electric motor. In such embodiments, the complexity of the position control system may be substantially reduced (e.g., as compared to a position control system that utilizes a hydraulic cylinder to move the reel along the arm, in which conduits, valve(s), and pump(s) are used to power and control the hydraulic cylinder), thereby reducing the cost and duration of maintenance operations. In addition, because the reel is driven to move along the arm using the motor (e.g., electric motor), the driver, and the carriage, the position of the reel along the arm may be more precisely controlled (e.g., as compared to a position control system that utilizes a hydraulic cylinder to move the reel along the arm).

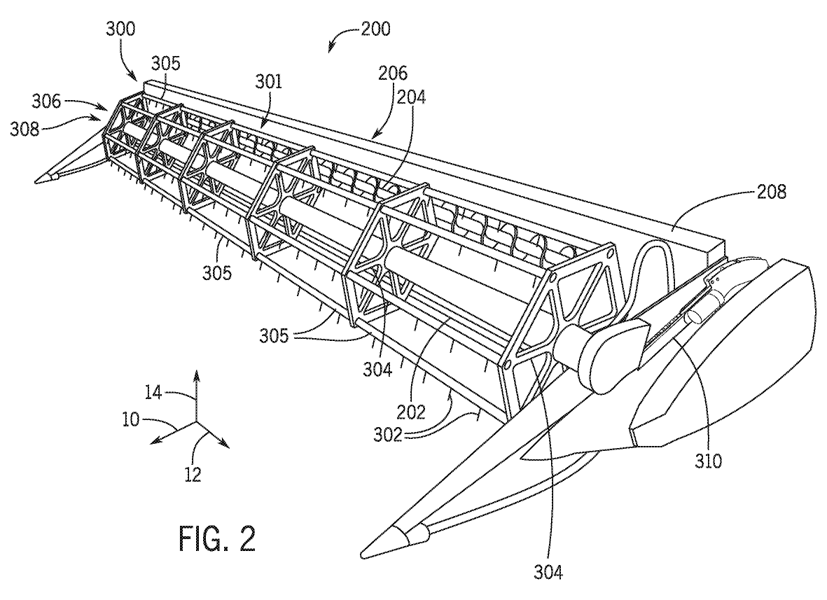

FIG. 2 is a perspective view of an embodiment of a header 200 that may be employed within the agricultural harvester of FIG. 1. In the illustrated embodiment, the header 200 includes a cutter bar assembly 202 that cuts a portion of each crop (e.g., a stalk), thereby separating the crop from the soil. As illustrated, the cutter bar assembly 202 extends along a substantial portion of the width of the header 200 (e.g., the extent of the header 200 along a lateral axis 12). The cutter bar assembly includes a blade support, a stationary guard assembly, and a moving blade assembly. The moving blade assembly is fixed to the blade support (e.g., above the blade support with respect to a vertical axis 14 of the header 200), and the blade support/moving blade assembly is driven to oscillate relative to the stationary guard assembly. In certain embodiments, the blade support/moving blade assembly is driven to oscillate by a driving mechanism positioned at the lateral center of the header. However, in other embodiments, the blade support/moving blade assembly may be driven by another suitable mechanism (e.g., located at any suitable position on the header). As the harvester is driven through a field, the cutter bar assembly 202 engages crops within the field, and the moving blade assembly cuts the crops (e.g., the stalks of the crops) in response to engagement of the cutter bar assembly 202 with the crops.

In the illustrated embodiment, the header 200 includes an auger 204 that rotates. The auger 204 is positioned rearward of the cutter bar assembly 202 relative to a longitudinal axis 10 of the header 200. The auger 204 may be driven to rotate by any suitable drive mechanism, such as an electric motor or a hydraulic motor. The auger 204 includes flighting that engages the cut crops and to drive the cut crops laterally inwardly as the auger 204 rotates.

In the illustrated embodiment, the crops cut by the cutter bar assembly 202 are directed toward the auger 204 by a reel assembly 300 (e.g., agricultural harvester reel assembly), thereby substantially reducing the possibility of the cut crops falling onto the surface of the field. The reel assembly 300 includes a reel 301 having multiple tines 302, and the reel 301 includes a rotating structure 304 that is driven to rotate (e.g., by one or more electric motors, by one or more hydraulic motors, etc.). Furthermore, the reel 301 includes multiple bat tubes 305 rotatably coupled to the rotating structure 304, and a respective set of tines 302 is coupled to each bat tube 305. The reel assembly 300 includes a tine rotation mechanism 306 (e.g., cam and follower assembly or parallel state assembly). The tine rotation mechanism 306 is drives the bat tubes 305 to rotate relative to the rotating structure 304 (e.g., in response to rotation of the rotating structure 304). Accordingly, the tines 302 rotate in a first pattern (e.g., circular pattern) about the rotational axis of the rotating structure 304 and in second patterns (e.g., circular patterns or oscillating patterns) about the rotational axes of respective bat tubes 305. The tines engage the cut crops and to urge the cut crops to move toward the auger. In response to engagement with the flighting of the auger 204, the cut crops are driven laterally inwardly, thereby enabling the cut crops to move through an opening 206 in the header 200 to the inlet of the agricultural crop processing system.

In the illustrated embodiment, the cutter bar assembly 202 is flexible along the width of the header 200 (e.g., the extent of the header 200 along the lateral axis 12). The cutter bar assembly 202 is supported by multiple arm assemblies distributed along the width of the header 200 (e.g., along the lateral axis 12 of the header 200). Each arm assembly is mounted to a frame 208 of the header 200 and includes an arm that rotates about the lateral axis 12 and/or move along the vertical axis 14 relative to the frame. Each rotatable/movable arm is coupled to the cutter bar assembly 202, thereby enabling the cutter bar assembly 202 to flex during operation of the harvester. The flexible cutter bar assembly may follow the contours of the field, thereby enabling the cutting height (e.g., the height at which each crop is cut) to be substantially constant along the width of the header 200 (e.g., the extent of the header 200 along the lateral axis 12). While the cutter bar assembly 202 is flexible in the illustrated embodiment, in other embodiments, the cutter bar assembly may be rigid.

In the illustrated embodiment, the reel 301 is supported by a first arm 308 rotatably coupled to the frame 208 and by a second arm 310 rotatably coupled to the frame 208. In certain embodiments, an actuator is coupled to each arm and drives the arm to rotate about the lateral axis 12, thereby controlling a position of the reel 301 relative to the frame 208 with respect to the vertical axis 14 (e.g., to control engagement of the tines with the cut crops). While the reel 301 is supported by two arms in the illustrated embodiment, in other embodiments, the reel may be supported by more or fewer arms.

In certain embodiments, the first arm 308 has a first internal passage, and the second arm 310 has a second internal passage. In addition, the reel assembly 300 includes a position control system that controls the position of the reel 301 along the lengths of the arms. In certain embodiments, the position control system includes a first motor (e.g., electric motor) having a first shaft, and the position control system includes a second motor (e.g., electric motor) having a second shaft. In addition, the position control system includes a first driver (e.g., first threaded shaft) non-rotatably coupled to the first shaft of the first motor. The first driver is disposed within the first internal passage of the first arm, and the first motor drives the first driver to rotate. The position control system also includes a second driver (e.g., second threaded shaft) non-rotatably coupled to the second shaft of the second motor. The second driver is disposed within the second internal passage of the second arm, and the second motor drives the second driver to rotate. Furthermore, the position control system includes a first carriage coupled to the reel 301. The first carriage is disposed within the first internal passage of the first arm, and the first driver drives the first carriage to move through the first internal passage along a length of the first arm in response to rotation of the first driver. The position control system also includes a second carriage coupled to the reel. The second carriage is disposed within the second internal passage of the second arm, and the second driver is configured to drives the second carriage to move through the second internal passage along a length of the second arm in response to rotation of the second driver. Accordingly, the position control system may control the position of the reel 301 along the lengths of the arms.

Because the drivers and the carriages are disposed within the internal passages of the respective arms, the arms may substantially block dirt, debris, and chaff, which may be present in significant amounts during operation of the agricultural harvester, from engaging the drivers and the carriages, thereby substantially reducing cleaning and maintenance operations (e.g., as compared to actuators, such as hydraulic cylinders, positioned outside the arms). In certain embodiments, the motors may include electric motors, such that the reel is driven to move along the arms using the electric motors. In such embodiments, the complexity of the position control system may be substantially reduced (e.g., as compared to a position control system that utilizes hydraulic cylinders to move the reel along the arms, in which conduits, valve(s), and pump(s) are used to power and control the hydraulic cylinders), thereby reducing the cost and duration of maintenance operations. In addition, because the reel is driven to move along the arms using the motors (e.g., electric motors), the drivers, and the carriages, the position of the reel along the arms may be more precisely controlled (e.g., as compared to a position control system that utilizes hydraulic cylinders to move the reel along the arms).

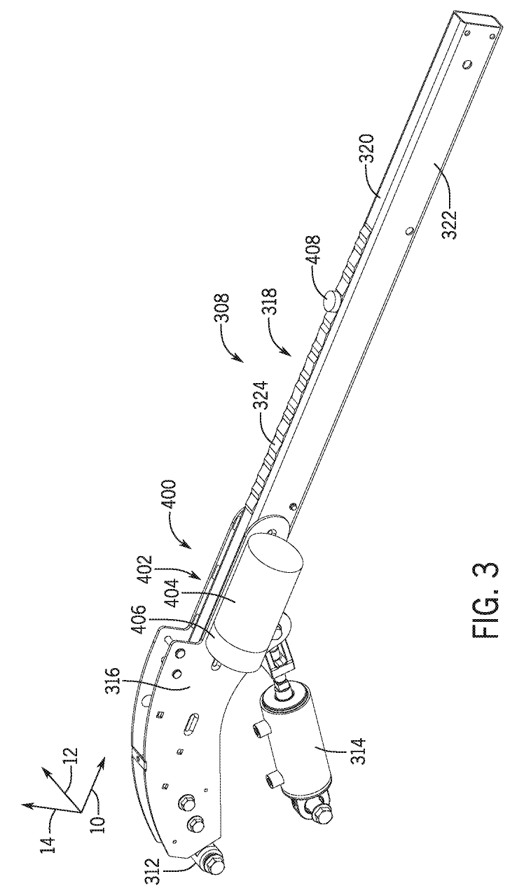

FIG. 3 is a perspective view of an embodiment of an arm (e.g., the first arm 308) and an embodiment of a position control system 400 that may be employed within the header of FIG. 2. As previously discussed, each arm supports the reel of the reel assembly. In the illustrated embodiment, the first arm 308 is pivotally coupled to the frame of the header via a first pivot joint 312 that enables the first arm 308 to pivot about the lateral axis 12. In certain embodiments, the second arm is pivotally coupled to the frame of the header via a second pivot joint that enables the second arm to pivot about the lateral axis. Furthermore, in the illustrated embodiment, the reel assembly includes a first actuator 314 (e.g., hydraulic cylinder) pivotally coupled to the first arm 308 and to the frame of the header. In certain embodiments, the reel assembly includes a second actuator (e.g., hydraulic cylinder) pivotally coupled to the second arm and to the frame of the header. Each actuator drives the respective arm to rotate about the lateral axis 12, thereby controlling a position of the reel relative to the frame of the header with respect to the vertical axis 14 (e.g., to control engagement of the tines with the cut crops).

In the illustrated embodiment, the first arm 308 has an internal passage that houses components of the position control system 400. The position control system 400 includes an electric motor 402 having a shaft. In the illustrated embodiment, the electric motor 402 includes a housing 404, and the shaft rotates relative to the housing 404. The housing 404 may be formed from any suitable material(s) (e.g., aluminum, steel, composite material(s), etc.) In the illustrated embodiment, the housing 404 is coupled to an exterior surface 316 of the first arm 308 via a suitable coupling assembly (e.g., including bracket(s), fastener(s), adhesive(s), etc.). However, in other embodiments, the electric motor may be disposed within the internal passage of the first arm. Furthermore, while the electric motor 402 includes the housing 404 in the illustrated embodiment, in other embodiments (e.g., in embodiments in which the electric motor is disposed within the internal passage), the housing may be omitted. In addition, while the position control system 400 includes the electric motor in the illustrated embodiment, in other embodiments, the position control system may include another suitable type of motor, such as a hydraulic motor or a pneumatic motor.

In addition, as discussed in detail below, the position control system 400 includes a driver non-rotatably coupled to the shaft of the electric motor 402. The driver is disposed within the internal passage of the first arm 308, and the electric motor 402 drives the driver to rotate. In certain embodiments, the driver includes a threaded shaft that extends along a length of the first arm 308. In the illustrated embodiment, the position control system 400 includes a gear assembly 406 that non-rotatably couples the shaft of the electric motor 402 to the driver. In certain embodiments (e.g., in embodiments in which the shaft of the electric motor is not aligned with the driver), the gear assembly 406 is configured to redirects the rotational motion of the electric motor shaft to the driver (e.g., via bevel gears, etc.). Furthermore, in certain embodiments, the gear assembly includes reduction gears configured to that drive the driver to rotate at a slower rotation rate than the rotation rate of the shaft of the electric motor. While the shaft of the electric motor 402 is non-rotatably coupled to the driver via the gear assembly 406 in the illustrated embodiment, in other embodiments, the gear assembly may be omitted. For example, in certain embodiments, the shaft of the electric motor may be directly non-rotatably coupled to the driver. Furthermore, in certain embodiments, the shaft of the electric motor may be non-rotatably coupled to the driver via flexible shaft(s) and/or other suitable type(s) of connection(s) (e.g., including the gear assembly).

In addition, as discussed in detail below, the position control system 400 includes a carriage coupled to the reel. The carriage is disposed within the internal passage of the first arm 308, and the driver drives the carriage to move through the internal passage along the length of the first arm in response to rotation of the driver. Accordingly, the position control system may control the position of the reel along the length of the first arm 308. As previously discussed, in certain embodiments, the driver may include a threaded shaft. In such embodiments, the carriage may include a ball assembly engaged with the threaded shaft. Accordingly, as the threaded shaft is driven to rotate by the electric motor, rotation of the threaded shaft drives the carriage along the length of the first arm via interaction between the threaded shaft and the ball assembly.

In the illustrated embodiment, the first arm 308 has a slot 318 extending through a top side 320 of the first arm 308. In addition, the position control system 400 includes a mount 408 coupled to the carriage and extending through the slot 318 in the first arm 308. The mount 408 is configured to coupled to the reel of the reel assembly. For example, in certain embodiments, the mount may be coupled to the rotating structure of the reel via a bearing assembly. Furthermore, in certain embodiments, the mount may be coupled to a sleeve disposed about the first arm, and the sleeve may be coupled to the rotating structure of the reel via a bearing assembly. While the slot 318 extends through the top side of the first arm 308 in the illustrated embodiment, in other embodiments, the slot may extend through an inner lateral side 322 of the first arm 308. In such embodiments, the mount may extend through the slot in the inner lateral side of the first arm. While the position control system 400 includes the mount 408 in the illustrated embodiment, in other embodiments, the mount may be omitted. In such embodiments (e.g., in embodiments in which the slot extends through the inner lateral side of the first arm), the rotating structure of the reel may be coupled to the carriage via a bearing assembly.

In the illustrated embodiment, the reel assembly includes a collapsible cover 324 that covers the slot 318 while enabling the mount 408 to move along the length of the first arm 308. The collapsible cover 324 is coupled to the mount 408, and the collapsible cover 324 includes two sections positioned on opposite sides of the mount 408. As the mount 408 moves toward one longitudinal end of the slot 318, the section of the collapsible cover 324 positioned between the mount 308 and the one longitudinal end collapses, while the other section expands. As a result, the collapsible cover 324 may cover the slot 318 throughout the range of motion of the mount. The collapsible cover 324 may be formed from any suitable material(s), such as a flexible corrugated material, a resilient material, etc. The collapsible cover 324 blocks dirt, debris, and chaff from entering the internal passage 326 during operation of the agricultural harvester. While the reel assembly includes the collapsible cover 324 in the illustrated embodiment, in other embodiments, the collapsible cover may be omitted. In such embodiments, the slot may be open, or the slot may be at least partially covered by a rigid cover coupled to the mount and moves with the mount.

Because the driver and the carriage are disposed within the internal passage of the first arm 308, the first arm 308 may substantially block dirt, debris, and chaff, which may be present in significant amounts during operation of the agricultural harvester, from engaging the driver and the carriage, thereby substantially reducing cleaning and maintenance operations (e.g., as compared to an actuator, such as a hydraulic cylinder, positioned outside the arm). Furthermore, because the reel is driven to move along the first arm 308 using the electric motor 402, the complexity of the position control system may be substantially reduced (e.g., as compared to a position control system that utilizes a hydraulic cylinder to move the reel along the arm, in which conduits, valve(s), and pump(s) are used to power and control the hydraulic cylinder), thereby reducing the cost and duration of maintenance operations. In addition, because the reel is driven to move along the first arm 308 using the electric motor 402, the weight of the position control system may be substantially reduced (e.g., as compared to a position control system that utilizes a hydraulic cylinder to move the reel along the arm). As a result, less power may be utilized by the first actuator 314 to lift the reel, thereby increasing efficiency of the agricultural harvesting process.

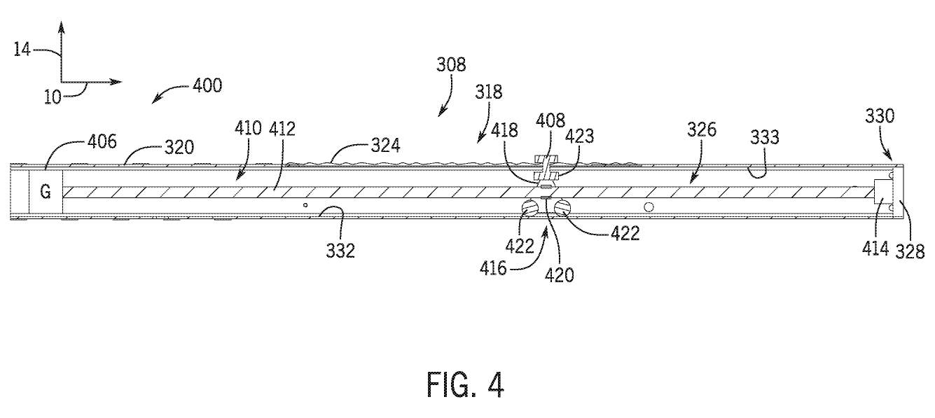

FIG. 4 is a cross-sectional view of a portion of the arm (e.g., the first arm 308) and a portion of the position control system 400 of FIG. 3. As previously discussed, the position control system 400 includes a driver 410 non-rotatably coupled to the shaft of the electric motor, and the electric motor drives the driver 410 to rotate. As illustrated, the driver 410 is disposed within the internal passage 326 of the first arm 308. In the illustrated embodiment, the driver 410 includes a threaded shaft 412. The threads of the threaded shaft 412 may extend along at least a portion of the length of the threaded shaft 412. For example, in certain embodiments, the threads may extend along a substantial portion (e.g., an entirety) of the length of the slot 318.

In the illustrated embodiment, the first arm 308 includes an end cap 328 positioned at a longitudinal end 330 of the internal passage 326. The end cap 328 blocks dirt, debris, and chaff from entering the internal passage 326 during operation of the agricultural harvester. The end cap 328 may be formed from any suitable material(s), such as metal(s), polymeric material(s), composite material(s), etc. In the illustrated embodiment, the position control system 400 includes a bearing 414 coupled to the end cap 328 and to the threaded shaft 412. The bearing 414 supports the threaded shaft 412 within the internal passage 326 and to enable the threaded shaft 412 to rotate relative to the first arm 308. The bearing 414 may include any suitable type(s) of bearing(s), such as ball bearing(s), roller bearing(s), etc. While the threaded shaft 412 is supported by the bearing 414 coupled to the end cap 328 in the illustrated embodiment, in certain embodiments, the threaded shaft may be supported by other suitable support component(s) (e.g., alone or in combination with the bearing couple to the end cap), such as a bushing coupled to the end cap, bearing(s) disposed along the length of the threaded shaft, bushing(s) disposed along the length of the threaded shaft, etc. Furthermore, in the illustrated embodiment, the threaded shaft 412 is coupled to the gear assembly 406, and the gear assembly 406 also supports the threaded shaft 412 within the internal passage 326. However, in other embodiments (e.g., in embodiments in which the electric motor is disposed within the internal passage), the threaded shaft may be coupled to the shaft of the electric motor, and the shaft of the electric motor may support the threaded shaft within the internal passage.

In addition, as previously discussed, the position control system 400 includes a carriage 416 coupled to the reel of the reel assembly. As illustrated, the carriage 416 is disposed within the internal passage 326 of the first arm 308, and the threaded shaft 412 of the driver 410 drives the carriage 416 to move through the internal passage 326 along the length of the first arm 308 in response to rotation of the threaded shaft 412. In the illustrated embodiment, the carriage 416 includes a frame 418 and a ball assembly 420 (e.g., forming a ball screw with the threaded shaft). The ball assembly 420 includes a tube disposed about the threaded shaft 412 and coupled to the frame 418 of the carriage 416. The ball assembly 420 also includes multiple balls disposed within channels of the tube and engaged with the threads of the threaded shaft 412. Accordingly, rotation of the threaded shaft 412 drives the ball assembly 420 to move along the threaded shaft 412, thereby driving the carriage 416 to move along the length of the first arm 308. Due to the interaction between the ball assembly and the threaded shaft, movement of the reel along the length of the first arm may be precisely controlled (e.g., as compared to a position control system having a hydraulic cylinder that moves the reel along the length of the arm). While the carriage 416 includes the ball assembly 420 in the illustrated embodiment, in other embodiments, the carriage may include another suitable device that engages the threaded shaft to facilitate movement of the carriage in response to rotation of the threaded shaft, such as a nut (e.g., forming a lead screw with the threaded shaft) or a roller assembly (e.g., forming a roller screw with the threaded shaft).

As illustrated, the mount 408 is coupled to the frame 418 of the carriage 416. Accordingly, movement of the carriage 416 along the length of the first arm 308 drives the reel to move along the length of the first arm 308. In addition, in the illustrated embodiment, the carriage 416 includes two rollers 422 rotatably coupled to the carriage frame 418. The rollers 422 to facilitate movement of the carriage 416 through the internal passage 326, thereby reducing the power utilized by the electric motor to drive the carriage 416 through the internal passage 326. In the illustrated embodiment, each roller 422 is engaged with a bottom inner surface 332 of the first arm 308. Accordingly, the rollers 422 facilitate transfer of a portion of the weight of the reel to the first arm 308. For example, a portion of the weight of the reel is supported by the mount 408, which is supported by the carriage 416, and the carriage 416 is supported by the first arm 308 via the rollers 422. Because the carriage 416 is disposed within the internal passage 326 of the first arm 308, the first arm 308 (e.g., including the collapsible cover 324 and the end cap 328) may substantially block dirt, debris, and chaff, which may be present in significant amounts during operation of the agricultural harvester, from accumulating on the bottom inner surface 332, thereby facilitating rotation of the rollers 422.

In the illustrated embodiment, the carriage 416 includes a bushing 423 that engages a top inner surface 333 of the first arm 308 (e.g., at opposite lateral sides of the slot 318). The bushing 423 facilitates movement of the carriage 416 through the internal passage 326 and to stabilize the carriage 416 within the internal passage 326. For example, because the rollers 422 engage the bottom inner surface 332 and the bushing 423 engages the top inner surface 333, vibrations and movement of the reel in a generally vertical direction perpendicular to the length of the first arm 308 may be substantially reduced, thereby obviating a sleeve disposed about the first arm. As a result, the energy utilized to drive the reel along the length of the first arm may be substantially reduced (e.g., as compared to a position control system having a sleeve in frictional contact with one or more outer surfaces of the first arm).

While the carriage 416 includes two rollers 422 and one bushing 423 in the illustrated embodiment, in other embodiments, the carriage may include more or fewer rollers (e.g., 0, 1, 3, 4, 5, 6, 7, 8, or more) and more or fewer bushings (e.g., 0, 2, 3, 4, 5, 6, or more). For example, in certain embodiments, the roller(s) may be omitted and/or the bushing(s) may be omitted. Furthermore, while the roller(s) 422 are engaged with the bottom inner surface 332 of the first arm 308 in the illustrated embodiment, in certain embodiments, at least one roller may engage another suitable inner surface of the first arm (e.g., alone or in combination with the roller(s) engaged with the bottom inner surface). In addition, while the bushing(s) 423 are engaged with the top inner surface 333 in the illustrated embodiment, in certain embodiments, at least one bushing may engage another suitable inner surface of the first arm (e.g., alone or in combination with the bushing(s) engaged with the top inner surface).

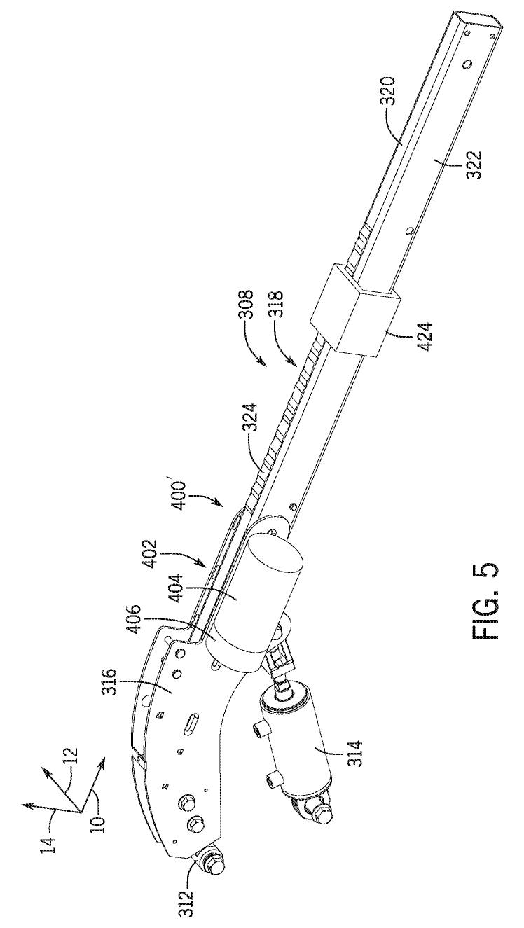

FIG. 5 is a perspective view of the arm (e.g., the first arm 308) of FIG. 3 and another embodiment of a position control system 400’ that may be employed within the header of FIG. 2. In the illustrated embodiment, the position control system 400’ includes a sleeve 424 disposed about the first arm 308 and coupled to the mount. In the illustrated embodiment, the mount extends through the slot 324 in the top side 320 of the first arm 308. However, in other embodiments, the mount may extend through a slot in the inner lateral side 322 of the first arm 308, through a slot in an outer lateral side of the first arm, or through a slot in a bottom side of the first arm. Furthermore, in certain embodiments, multiple mounts may extend through multiple slots in multiple sides of the arm (e.g., the top side and the bottom side, the inner lateral side and the outer lateral side, etc.), and each mount may be coupled to the sleeve.

The sleeve 424 is coupled to the reel. For example, in certain embodiments, the sleeve 424 may be coupled to the rotating structure of the reel via a bearing assembly. In certain embodiments, the sleeve 424 may contact the top side 320, the inner lateral side 322, the bottom side, the outer lateral side, or a combination thereof, of the first arm 308. Contact between the sleeve and the side(s) of the first arm may reduce the vertical and/or lateral movement of the reel relative to the first arm. In certain embodiments, the sleeve may include at least one bushing that contacts respective side(s) of the first arm, thereby facilitating movement of the sleeve along the length of the first arm. While the position control system 400’ disclosed above with reference to FIG. 5 includes the sleeve 424, the other aspects of the position control system 400’ correspond to the position control system 400 disclosed above with reference to FIGS. 3-4, including the components, functions, and variations disclosed above with reference to FIGS. 3-4.

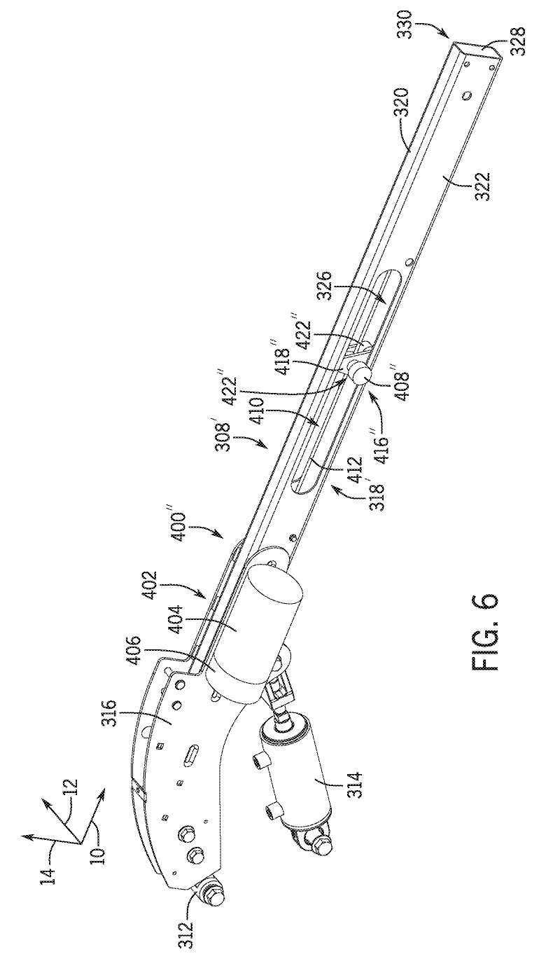

FIG. 6 is a perspective view of another embodiment of an arm (e.g., the first arm 308’) and a further embodiment of a position control system 400’’ that may be employed within the header of FIG. 2. In the illustrated embodiment, the first arm 308’ has a slot 318’ extending through the inner lateral side 322 of the first arm 308’. In addition, the slot 318 extending through the top side 320 of the first arm and the collapsible cover 324 covers the slot 318, as disclosed above with regard to the embodiments of FIGS. 3-5, are omitted. The other aspects of the first arm 308’ correspond to the first arm 308 disclosed above with reference to FIGS. 3-5, including the components, functions, and variations disclosed above with reference to FIGS. 3-5. While the first arm 308’ does not include a cover in the illustrated embodiment, in certain embodiments, the first arm 308’ may include a cover, such as a collapsible cover, as disclosed above with reference to FIGS. 3-5, covers the slot 318’.

As previously discussed, the position control system 400’’ includes the driver 410, which is non-rotatably coupled to the shaft of the electric motor 402, and the electric motor 402 drives the driver 410 to rotate. As illustrated, the driver 410 is disposed within the internal passage 326 of the first arm 308’. In the illustrated embodiment, the driver 410 includes the threaded shaft 412. The threads of the threaded shaft 412 extend along at least a portion of the length of the threaded shaft 412. For example, in certain embodiments, the threads may extend along a substantial portion (e.g., an entirety) of the length of the slot 318’.

In addition, as previously discussed, the position control system 400’’ includes the carriage 416’’, which is coupled to the reel of the reel assembly. As illustrated, the carriage 416’’ is disposed within the internal passage 326 of the first arm 308’, and the threaded shaft 412 of the driver 410 is configured to drives the carriage 416’’ to move through the internal passage 326 along the length of the first arm 308’ in response to rotation of the threaded shaft 412. The position control system 400’’ also includes the mount 408’’ coupled to the frame 418’’ of the carriage 416’’ and coupled to the reel of the reel assembly. In certain embodiments, the mount may be coupled to the rotating structure of the reel via a bearing assembly. Furthermore, in certain embodiments, the mount may be coupled to a sleeve disposed about the first arm, and the sleeve may be coupled to the rotating structure of the reel via a bearing assembly, as disclosed above with reference to FIG. 5. While the slot 318’ extends through the inner lateral side 322 of the first arm 308’ in the illustrated embodiment, in other embodiments, the slot may extend through another suitable side of the first arm, such as the top side of the first arm, as disclosed above with reference to FIGS. 3-5. While the position control system 400’’ includes the mount 408’’ in the illustrated embodiment, in other embodiments, the mount may be omitted. In such embodiments, the rotating structure of the reel may be coupled to the carriage via a bearing assembly.

In the illustrated embodiment, the carriage 416’’ includes three rollers 422’’ (e.g., primary rollers) rotatably coupled to the frame 418’’ of the carriage 416’’. The rollers 422’’ are configured to facilitate movement of the carriage 416’’ through the internal passage 326, thereby reducing the power utilized by the electric motor 402 to drive the carriage 416’’ through the internal passage 326. In the illustrated embodiment, two rollers 422’’ are engaged with the bottom inner surface of the first arm 308’, and one roller is engaged with the top inner surface of the first arm 308’. The two bottom rollers 422’’ facilitate transfer of a portion of the weight of the reel to the first arm 308’, and the top roller stabilizes the carriage 416’’ within the internal passage 326. For example, because the rollers 422’’ engage the top and bottom inner surfaces of the first arm 308’, vibrations and movement of the reel in a generally vertical direction perpendicular to the length of the first arm 308’ may be substantially reduced, thereby obviating a sleeve disposed about the first arm. As a result, the energy utilized to drive the reel along the length of the first arm may be substantially reduced (e.g., as compared to a position control system having a sleeve in frictional contact with one or more outer surfaces of the first arm). Furthermore, because the carriage 416’’ is disposed within the internal passage 326 of the first arm 308’, the first arm 308’ (e.g., including the collapsible cover, if present, and the end cap 328) may substantially block dirt, debris, and chaff, which may be present in significant amounts during operation of the agricultural harvester, from accumulating on the top and bottom inner surfaces, thereby facilitating rotation of the rollers 422’’.

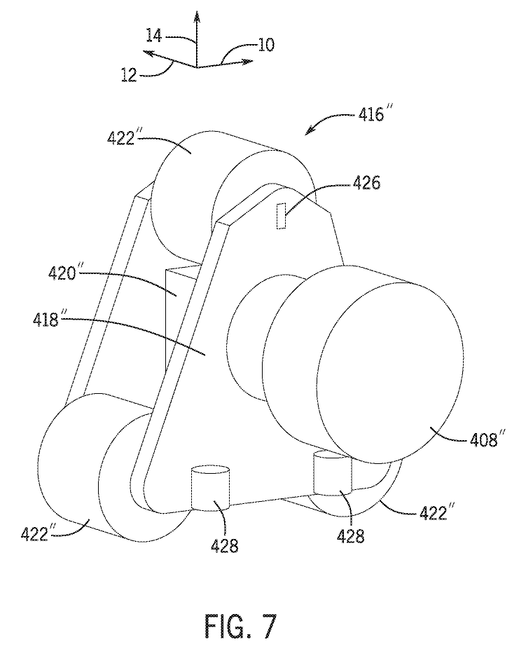

FIG. 7 is a perspective view of an embodiment of the carriage 416’’ that may be employed within the position control system of FIG. 6. In the illustrated embodiment, the carriage 416’’ includes the ball assembly 420’’ (e.g., forming a ball screw with the threaded shaft). The ball assembly 420’’ includes a tube disposed about the threaded shaft and coupled to the frame 418’’ of the carriage 416’’. The ball assembly 420’’ also includes multiple balls disposed within channels of the tube and engaged with the threads of the threaded shaft. Accordingly, rotation of the threaded shaft drives the ball assembly 420’’ to move along the threaded shaft, thereby driving the carriage 416’’ to move along the length of the first arm. Due to the interaction between the ball assembly and the threaded shaft, movement of the reel along the length of the first arm may be precisely controlled (e.g., as compared to a position control system having a hydraulic cylinder that moves the reel along the length of the arm). While the carriage 416’’ includes the ball assembly 420’’ in the illustrated embodiment, in other embodiments, the carriage may include another suitable device that engages the threaded shaft to facilitate movement of the carriage in response to rotation of the threaded shaft, such as a nut (e.g., forming a lead screw with the threaded shaft) or a roller assembly (e.g., forming a roller screw with the threaded shaft).

As previously discussed, the carriage 416’’ includes three primary rollers 422’’ rotatably coupled to the frame 418’’ of the carriage 416’’. The primary rollers 422’’ facilitate movement of the carriage 416’’ through the internal passage of the first arm, thereby reducing the power utilized by the electric motor to drive the carriage 416’’ through the internal passage. In the illustrated embodiment, two primary rollers 422’’ engage the bottom inner surface of the first arm, and one primary roller 422’’ engages the top inner surface of the first arm. While two primary rollers 422’’ to engage the bottom inner surface of the first arm in the illustrated embodiment, in other embodiments, more or fewer primary rollers may engage the bottom inner surface (e.g., 0, 1, 3, or more). In addition, while one primary roller 422’’ engages the top inner surface of the first arm in the illustrated embodiment, in other embodiments, more or fewer primary rollers may engage the top inner surface (e.g., 0, 2, 3, or more). Furthermore, while the carriage 416’’ includes three primary rollers 422’’ in the illustrated embodiment, in other embodiments, the carriage may include more or fewer primary rollers (e.g., 0, 1, 2, 4, 5, 6, 7, 8, or more). For example, in certain embodiments, the primary rollers may be omitted. In addition, in certain embodiments (e.g., in embodiments in which the primary rollers are omitted), the carriage may include one or more bushings that engages one or more inner surfaces of the arm.

In the illustrated embodiment, the carriage 416’’ includes a tensioning system 426 that urges the primary rollers 422’’ against the respective inner surfaces of the first arm. For example, the tensioning system 426 may include one or more springs that urge the primary rollers 422’’ outwardly with respect to the frame 418’’. The tensioning system 426 may further reduce vibrations and movement of the reel in the generally vertical direction perpendicular to the length of the first arm (e.g., as compared to the primary rollers alone), thereby enhancing the accuracy of the reel placement (e.g., relative to the cutter bar assembly). While the carriage 416’’ includes the tensioning system 426 in the illustrated embodiment, in other embodiments, the tensioning system may be omitted.

In the illustrated embodiment, the carriage 416’’ includes secondary rollers 428 rotatably coupled to the carriage 418’’ and positioned on each lateral side of the carriage 416’’. The secondary rollers 428 engage the lateral inner surfaces of the first arm, thereby enhancing the stability of the carriage 416’’ within the internal passage of the first arm. For example, the secondary rollers 428 may reduce lateral movement of the carriage 416’’ within the internal passage. In the illustrated embodiment, the carriage 416’’ includes two secondary rollers 428 on each lateral side of the carriage 416’’. However, in other embodiments, the carriage may include more or fewer secondary rollers on each lateral side (e.g., 0, 1, 3, 4, or more). For example, in certain embodiments, the secondary rollers may be omitted. While the position control system 400’’ disclosed above with reference to FIGS. 6-7 includes a different carriage than the carriage disclosed above with reference to FIGS. 3-4, the other aspects of the position control system 400’’ correspond to the position control system 400 disclosed above with reference to FIGS. 3-4, including the components, functions, and variations disclosed above with reference to FIGS. 3-4.

While the position control system includes a driver having a threaded shaft in the embodiments disclosed above with regard to FIGS. 3-7, in certain embodiments, the driver may have another suitable configuration. For example, in certain embodiments, the driver may include a gear and a chain. In such embodiments, the shaft of the electric motor may be non-rotatably coupled to the gear, and the electric motor may drive the gear to rotate, thereby driving the chain to rotate. The carriage may be coupled to the chain. Accordingly, rotation of the chain drives the carriage to move through the internal passage along the length of the arm. Furthermore, in certain embodiments, the driver may include a wheel and a belt. In such embodiments, the shaft of the electric motor may be non-rotatably coupled to the wheel, and the electric motor may drive the wheel to rotate, thereby driving the belt to rotate. The carriage may be coupled to the belt. Accordingly, rotation of the belt drives the carriage to move through the internal passage along the length of the arm. In addition, in certain embodiments, the driver may include a pinion. In such embodiments, the shaft of the electric motor may be non-rotatably coupled to the pinion, and the electric motor may drive the pinion to rotate. The carriage may include a rack engaged with the pinion. Accordingly, due to engagement of the rack with the pinion, rotation of the pinion drives the carriage to move through the internal passage along the length of the arm. Furthermore, in certain embodiments, the position control system may include a fluid cylinder (e.g., pneumatic or hydraulic cylinder) disposed within the internal passage of the arm and coupled to the carriage. In such embodiments, the fluid cylinder may extend and retract to drive the carriage to move through the internal passage along the length of the arm.

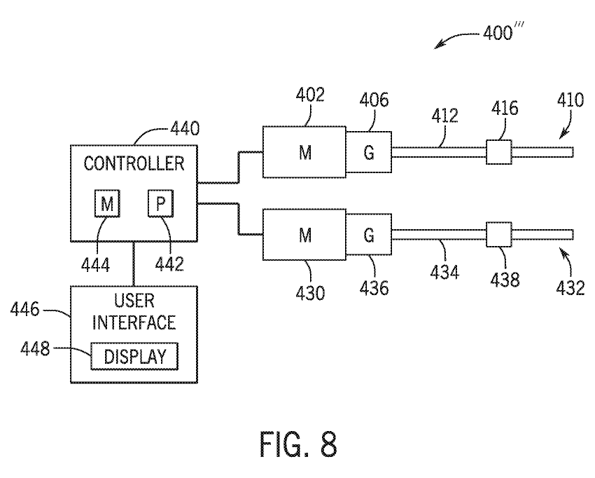

FIG. 8 is a block diagram of an embodiment of a portion of a position control system 400’’’. In the illustrated embodiment, the position control system 400’’’ includes a second electric motor 430 having a second shaft. The position control system 400’’’ also includes a second driver 432 non-rotatably coupled to the second shaft of the second electric motor 430. In the illustrated embodiment, the second driver 432 includes a second threaded shaft 434, and the position control system 400’’’ includes a second gear assembly 436 that non-rotatably couples the second shaft of the second electric motor 430 to the second threaded shaft 434 of the second driver 432. The second driver 432 may be disposed within a second internal passage of the second arm, and the second electric motor 430 may be configured to drive the second driver 432 to rotate. In addition, the position control system 400’’’ includes a second carriage 438 (e.g., including a second ball assembly engaged with the second threaded shaft 434) coupled to the reel. The second carriage 438 may be disposed within the second internal passage of the second arm, and the second driver 432 may drive the second carriage 438 to move through the second internal passage along a length of the second arm in response to rotation of the second driver.

In the illustrated embodiment, the position control system 400’’’ includes a controller 440 communicatively coupled to the electric motor 402 (e.g., first electric motor) and the second electric motor 430. In embodiments in which the position control system includes at least one pneumatic or hydraulic motor drives the respective driver to rotate, the controller may be communicatively coupled to the motor(s) via one or more valve assemblies (e.g., the controller may control the one or more valve assemblies to control fluid flow to the motor(s), thereby controlling the motor(s)). In certain embodiments, the controller 440 is an electronic controller having electrical circuitry that controls the first and second electric motors. In the illustrated embodiment, the controller 440 includes a processor 442, such as a microprocessor, and a memory device 444. The controller 440 may also include one or more storage devices and/or other suitable components. The processor 442 may be used to execute software, such as software for controlling the first and second electric motors, and so forth. Moreover, the processor 440 may include multiple microprocessors, one or more “general-purpose” microprocessors, one or more special-purpose microprocessors, and/or one or more application specific integrated circuits (ASICs), or some combination thereof. For example, the processor 440 may include one or more reduced instruction set (RISC) processors.

The memory device 444 may include a volatile memory, such as random access memory (RAM), and/or a nonvolatile memory, such as read-only memory (ROM). The memory device 44 may store a variety of information and may be used for various purposes. For example, the memory device 444 may store processor-executable instructions (e.g., firmware or software) for the processor 442 to execute, such as instructions for controlling the first and second electric motors, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the first and second electric motors, etc.), and any other suitable data. The controller may be positioned at any suitable location(s) on the agricultural harvester (e.g., as one element in one location or as multiple elements in multiple locations).

In the illustrated embodiment, the position control system 400’’’ includes a user interface 446 communicatively coupled to the controller 440. The user interface 446 to receives input from an operator and to provide information to the operator. The user interface 446 may include any suitable input device(s) for receiving input, such as a keyboard, a mouse, button(s), switch(es), knob(s), other suitable input device(s), or a combination thereof. In addition, the user interface 446 may include any suitable output device(s) for presenting information to the operator, such as speaker(s), indicator light(s), other suitable output device(s), or a combination thereof. In the illustrated embodiment, the user interface 446 includes a display 448 that presents visual information to the operator. In certain embodiments, the display 448 may include a touchscreen interface that receives input from the operator.

In certain embodiments, the controller 440 controls the first electric motor 402 and the second electric motor 430 based on input from the user interface 446. For example, the operator may provide an input to the user interface 446 indicative of instructions to move the reel along the lengths of the arms, and the user interface 446 may output a signal indicative of the instructions to the controller 440. The controller 440, in turn, may control the first and second electric motors based on the instructions. In certain embodiments, the controller 440 synchronizes operation of the first and second electric motors, thereby maintaining the orientation of the reel as the electric motors drive the reel to move along the lengths of the arms. For example, prior to harvesting operations, the operator may instruct the electric motors to drive the carriages into a fully extended position or a fully retracted position (e.g., by providing input to the user interface). In response, the controller may control the electric motors to drive the carriages into the fully extended or fully retracted position. With the carriages in the fully extended or fully retracted position, subsequent synchronized operation of the electric motors may drive the carriages through equal distances along the lengths of the arms, thereby maintaining the orientation of the reel as the reel moves along the lengths of the arms. While the position control system 400’’’ includes two electric motors, two gear assemblies, two drivers, and two carriages in the illustrated embodiment, in other embodiments, the position control system may include more or fewer electric motors, gear assemblies, drivers, and carriages (e.g., 1, 3, 4, or more). In such embodiments, the controller may control each electric motor.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A reel assembly for an agricultural harvester, comprising:
an arm configured to support a reel of the reel assembly, wherein the arm has an internal passage; and
a position control system, comprising:
a motor comprising a shaft;
a driver non-rotatably coupled to the shaft of the motor, wherein the driver is disposed within the internal passage of the arm, and the motor is configured to drive the driver to rotate; and
a carriage configured to couple to the reel, wherein the carriage is disposed within the internal passage of the arm, and the driver is configured to drive the carriage to move through the internal passage along a length of the arm in response to rotation of the driver.

2. The reel assembly of claim 1, wherein the driver comprises a threaded shaft.

3. The reel assembly of claim 2, wherein the carriage comprises a ball assembly engaged with the threaded shaft.

4. The reel assembly of claim 1, wherein the motor comprises an electric motor.

5. The reel assembly of claim 1, wherein the arm has a slot, the position control system comprises a mount coupled to the carriage and extending through the slot in the arm, and the mount is configured to couple to the reel of the reel assembly.

6. The reel assembly of claim 5, wherein the slot extends through a top side of the arm, or the slot extends through an inner lateral side of the arm.

7. The reel assembly of claim 5, comprising a collapsible cover configured to cover the slot.

8. The reel assembly of claim 5, wherein the position control system comprises a sleeve disposed about the arm and coupled to the mount, wherein the sleeve is configured to couple to the reel of the reel assembly.

9. A reel assembly for an agricultural harvester, comprising:
an arm configured to support a reel of the reel assembly, wherein the arm has an internal passage, and the arm comprises an end cap positioned at a longitudinal end of the internal passage; and
a position control system, comprising:
a motor comprising a shaft;
a threaded shaft non-rotatably coupled to the shaft of the motor, wherein the threaded shaft is disposed within the internal passage of the arm, the threaded shaft extends along a length of the arm, and the motor is configured to drive the threaded shaft to rotate;
a bearing coupled to the end cap and to the threaded shaft, wherein the bearing is configured to support the threaded shaft and to enable the threaded shaft to rotate; and
a carriage configured to couple to the reel, wherein the carriage is disposed within the internal passage of the arm, and the threaded shaft is configured to drive the carriage to move through the internal passage along the length of the arm in response to rotation of the threaded shaft.

10. The reel assembly of claim 9, wherein the carriage comprises a ball assembly engaged with the threaded shaft.

11. The reel assembly of claim 9, wherein the carriage comprises a roller engaged with an inner surface of the arm.

12. The reel assembly of claim 11, wherein the carriage comprises a tensioning system configured to urge the roller against the inner surface of the arm.

13. The reel assembly of claim 1, wherein the arm has a slot, the position control system comprises a mount coupled to the carriage and extending through the slot in the arm, and the mount is configured to couple to the reel of the reel assembly.

14. The reel assembly of claim 13, comprising a collapsible cover configured to cover the slot.

15. A reel assembly for an agricultural harvester, comprising:
a first arm configured to support a reel of the reel assembly, wherein the first arm has a first internal passage;
a second arm configured to support the reel of the reel assembly, wherein the second arm has a second internal passage; and
a position control system, comprising:
a first motor comprising a first shaft;
a second motor comprising a second shaft;
a first driver non-rotatably coupled to the first shaft of the first motor, wherein the first driver is disposed within the first internal passage of the first arm, and the first motor is configured to drive the first driver to rotate;
a second driver non-rotatably coupled to the second shaft of the second motor, wherein the second driver is disposed within the second internal passage of the second arm, and the second motor is configured to drive the second driver to rotate;
a first carriage configured to couple to the reel, wherein the first carriage is disposed within the first internal passage of the first arm, and the first driver is configured to drive the first carriage to move through the first internal passage along a length of the first arm in response to rotation of the first driver; and
a second carriage configured to couple to the reel, wherein the second carriage is disposed within the second internal passage of the second arm, and the second driver is configured to drive the second carriage to move through the second internal passage along a length of the second arm in response to rotation of the second driver.

16. The reel assembly of claim 15, wherein the first driver comprises a first threaded shaft, and the second driver comprises a second threaded shaft.

17. The reel assembly of claim 16, wherein the first carriage comprises a first ball assembly engaged with the first threaded shaft, and the second carriage comprises a second ball assembly engaged with the second threaded shaft.

18. The reel assembly of claim 15, wherein the position control system comprises a controller communicatively coupled to the first motor and to the second motor, the controller comprises a processor and a memory, and the controller is configured to control the first motor and the second motor.

19. The reel assembly of claim 18, wherein the controller is configured to synchronize operation of the first and second motors.

20. The reel assembly of claim 15, wherein the first arm has a first slot, the position control system comprises a first mount coupled to the first carriage and extending through the first slot in the first arm, the first mount is configured to couple to the reel of the reel assembly, the second arm has a second slot, the position control system comprises a second mount coupled to the second carriage and extending through the second slot in the second arm, and the second mount is configured to couple to the reel of the reel assembly.
